(19) United States
(12) Patent Application Publication
(10) Pub. No.: US 2007/0057524 A1
(43) Pub. Date: Mar. 15, 2007

(54) Driver's cab for a utility vehicle

(75) Inventors: Stephen Kramb, Aichwald (DE); Oswald Saiber, Horb (DE); Karl-Heinz Schuller, Aidlingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/567,464

(22) PCT Filed: Feb. 7, 2006
(86) PCT No.: PCT/EP04/08679

§ 371 Date: Oct. 19, 2006

(30) Foreign Application Priority Data
Aug. 7, 2003 (DE) 103 36 200.2

(51) Int. Cl. B60P 3/00

(52) U.S. Cl. 296/24.3

(57) ABSTRACT

The invention relates to a driver's cab for a utility vehicle, comprising two hollow profiled carriers that are connected to a carrier structure and are supported thereon in such a way that when forces (F) are applied to the front side, the hollow profiled carriers transmit said forces into the carrier structure. The aim of the invention is to improve passenger protection in a driver's cab for a utility vehicle. To this end, a crash element extending between two hollow profiled carriers is at least partially arranged in front of said hollow profiled carriers. Advantageously, in this way, impact forces are distributed between the transversal and longitudinal directions of the vehicle.

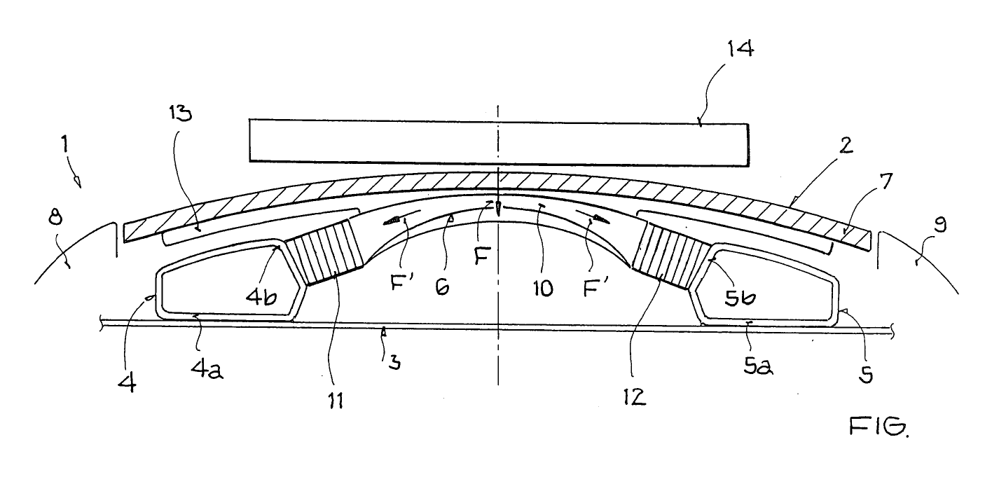

This application is a National Phase of PCT/EP2004/008679, filed Aug. 3, 2004, and claims the priority of DE 103 36 200.2, filed Aug. 7, 2003, the disclosures of which are expressly incorporated by reference herein.

The invention relates to a driver's cab for a utility vehicle and to crash energy management.

### BACKGROUND AND SUMMARY OF THE INVENTION

Utility vehicles are equipped with a driver's cab which is generally formed as a self-supporting body. In contrast to passenger vehicles, in the case of drivers' cabs no forward structure is provided. As a result, other measures are necessary in order to prevent intrusions in the case of a rectilinear or offset or oblique frontal impact against the drivers cab.

DE 101 24 271 A1 shows a basic supporting structure of a driver's cab for a utility vehicle. Two hollow profile supports are provided which are arranged below a floor plate belonging to the floor assembly and are extended beyond the floor plate in such a manner that, in a side view of the driver's cab, an angled design of the longitudinal members arises. In the case of a frontal impact, forces can be passed on into the supporting structure of the floor assembly by the outwardly protruding hollow profile supports.

Intrusions of the end wall can therefore be avoided, in particular if the hollow profile supports are adequately dimensioned.

An object of the invention to develop a driver's cab for a utility vehicle in such a manner that, with the existing force paths being maintained, the protection afforded by the driver's cab to the occupant is improved.

According to the invention, provision is made for the driver's cab to comprise two hollow profile supports which are connected to a supporting structure and are supported on the latter in such a manner that, in the case of forces acting on the front end, the hollow profile supports pass on forces into the supporting structure. In addition, a crash element is at least partially mounted in front of the two hollow profile supports. The crash element extends between the two hollow profile supports, with the result that, in the case of forces acting on the front end, the crash element absorbs them and passes them on into the hollow profile supports with energy being absorbed. The crash elements are designed in such a manner that the energy to be absorbed because of the impact is distributed and dissipated both in the longitudinal direction of the vehicle and in the transverse direction of the vehicle. The partial forward displacement of the crash element has the effect that the crash element is acted upon first in the case of an impact.

The crash element advantageously extends in the transverse direction of the vehicle in order to connect the two hollow profile supports to each other.

A forwardly displaced arrangement can be achieved if the crash element has a curved cross section, with free ends of the crash element being connected to the hollow profile supports.

The free ends of the curved crash element are preferably designed as deformable end parts in order to absorb energy in the case of an impact. The two deformable end parts can be connected to each other by a support part, with the curved cross section being produced both over the end parts and over the support part.

In a preferred embodiment, the supporting structure can be connected to a front gate of the driver's cab. As a result, the crash element can be moved at the same time as the front gate is opened.

To this end, each end part of the crash element can be fastened releasably to the corresponding hollow profile supports. This releasable fastening may be manufactured, for example, as a lock.

In a particularly preferred embodiment, the crash element is not only tubular or rod-shaped, but also extends over virtually the entire height of the front gate. This has the advantage that the crash element is acted upon irrespective of the height of the obstacle encountered and therefore forces can always be introduced into the supporting structure with energy being absorbed.

Other objects, advantages and novel features of the present invention will become apparent from the following detailed description of the invention when considered in conjunction with the accompanying drawing.

### BRIEF DESCRIPTION OF THE DRAWING

This Figure is an overhead cross-sectional view of a driver's cabin in accordance with an embodiment of the present invention.

### DETAILED DESCRIPTION OF THE DRAWING

The preferred embodiment is illustrated in the figure. The figure shows a cross section through a driver's cab 1 of a utility vehicle (not illustrated specifically). The driver's cab 1 is illustrated by its front end 2 which comprises an end wall 3 and two hollow profile supports 4 and 5 running in the vertical direction of the vehicle. A crash element 6 which connects the two hollow profile supports 4 and 5 to each other is arranged between the hollow profile supports 4 and 5. A front gate 7 which is bounded laterally by respective corner panels 8 and 9 forms the front termination of the front end 2.

The two hollow profile supports 4 and 5 have an essentially pentagonal cross section. The end side 4a or 5a, which points in the direction of the interior, bears flat against the end wall 3 and is fastened to the latter. A boundary wall 4b or 5b of the hollow profile support 4 or 5 is set at an angle to the end side 4a or 5a. The boundary wall 4b or 5b forms the connecting surface of the crash element 6.

The crash element 6 comprises a central support part 10 and end parts 11 and 12 arranged on both sides of the support part 10. The end parts 11 and 12 are designed deformably, so that energy can be absorbed by their deformation. The cross section of the crash element 6 is curved, so that the crash element 6 is at least partially mounted in front of the two hollow profile supports 4 and 5. The support part 10 is connected to the front gate 7 via a connecting piece 13. In order to be able also to reach regions behind the crash element 6 after the front gate 7 is opened, the connection between each end part 11 or 12 and the boundary wall 4b and 5b of the two hollow profiles 4, 5 is designed releaseably. It is possible to design this connection as a lock which is opened when the fastening of the front gate 7 is actuated. This also has the advantage that the crash element 6 can easily be replaced if it has been damaged in the case of an impact.

The manner of operation of the invention is as follows:

If there is contact between a stationary or moving obstacle 14 and the front end 2 of the driver's cab 1, the acting force F is conducted directly into the crash element 6. By means of the curved structure of the crash element 6, the force F is divided into two force paths F′ which act upon the end parts 11 and 12 and is passed on by deformation of them to the boundary walls 4b and 5b. The inclined bearing surface of the boundary wall 4b or 5b causes a further division of the force paths in the transverse direction of the vehicle and in the longitudinal direction of the vehicle.

In the case of a frontal impact, this distribution of the impact forces in the transverse direction of the vehicle and longitudinal direction of the vehicle permits a higher absorption of energy in the front end region of the driver's cab. At the same time, in the case of small impact forces, damage to the body shell structure can be avoided because the crash element 6 can then be exchanged in a manner favorable in terms of repair and costs.

The invention is not only restricted to the crash element explained in the exemplary embodiment but may also have different forms of configuration. However, it is important here that the crash element is at least partially mounted in front of the hollow profile supports and extends between these two in order to achieve a distribution of the impact forces.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-7. (canceled)

8. A driver's cab for a utility vehicle, comprising:
a driver's cab supporting structure;
two hollow profile supports connected to and supported on the supporting structure;
a crash element extending between and at least partially mounted in front of the two hollow profile supports,
wherein
the hollow profile supports are supported on the driver's cab supporting structure such that forces acting on a front surface of the hollow profiles are passed into the supporting structure,
a boundary wall of each hollow profile support is set at an angle to a rear wall of the hollow profile facing the driver's cab supporting structure, running parallel to the end wall, and
the boundary wall of each hollow profile is a connecting surface for the crash element.

9. The driver's cab as claimed in claim 8, wherein
the crash element extends in the transverse direction of the vehicle.

10. The driver's cab as claimed in claim 9, wherein
the crash element has a curved cross section, and
free ends of the crash element are connected to their corresponding hollow profile supports.

11. The driver's cab as claimed in claim 10, wherein
the free ends of the crash element are deformable end parts, and
the free ends are connected to each other by a support part of the crash element.

12. The driver's cab as claimed in claim 11, wherein
the support part of the crash element is connected to a front gate of the driver's cab.

13. The driver's cab as claimed in claim 12, wherein
the end parts of the crash element are releasably fastened to their corresponding hollow profile supports.

14. The driver's cab as claimed in one of claim 12, wherein the crash element extends vertically over essentially an entire height of the front gate.
